(19) United States
(12) Patent Application Publication
(10) Pub. No.: US 2017/0356847 A1
(43) Pub. Date: Dec. 14, 2017

(54) MEASURING DEVICE

(71) Applicant: IFE Innovative Forschungs- und Entwicklungs GmbH & Co. KG, Harrislee (DE)

(72) Inventors: Thomas Willuweit, Hof (DE); Ralf Griesbach, Hof (DE)

(21) Appl. No.: 15/651,695

(22) Filed: Jul. 17, 2017

Related U.S. Application Data
(63) Continuation of application No. 15/029,289, filed on Jul. 5, 2016.

(30) Foreign Application Priority Data
Oct. 14, 2013 (EP) 13188553.5
May 2, 2014 (EP) 14166852.5

(51) Int. Cl. G01N 21/64; G01J 3/02; G01N 21/25; G01J 3/32; G01J 3/10; G01J 3/28; G01J 3/44

(52) U.S. Cl. CPC G01N 21/64; G01J 3/10; G01J 3/0272; G01J 3/28; G01N 21/251; G01J 3/0218; G01J 3/32; G01J 3/0291; G01J 3/0264; G01J 3/0256; G01N 21/645; G01J 3/4406; G01N 2201/08; G01N 2201/024

(57) ABSTRACT

The invention provides a measuring device for analyzing a luminescent sample and, in particular, for measuring the concentration of at least one analyte in a luminescent sample, comprising: a housing with a sample receptacle space for accommodating a sample container; a sample container for accommodating the luminescent sample; a radiation receiver apparatus for receiving radiation emitted by the luminescent sample; and an evaluation apparatus for evaluating the radiation from the luminescent sample received by the radiation receiver apparatus. The invention moreover provides a measuring device comprising a base part and a measuring head arranged at the base part in an interchangeable manner, wherein the measuring head is embodied to analyze the luminescent sample or it is embodied as a spectrometer measuring head.

The present application is a continuation of U.S. patent application Ser. No. 15/029,289, filed Jul. 5, 2016, incorporated herein by reference in its entirety, which itself was a United States National Stage Application of PCT/EP2014/071977, filed Oct. 14, 2014, incorporated herein by reference in its entirety, which itself claimed the benefit of European Patent Application Serial No. EP 13188553.5, filed Oct. 14, 2013, incorporated herein by reference in its entirety, and European Patent Application Serial No. EP 14166852.5, filed May 2, 2014, incorporated herein by reference in its entirety.

The present invention relates to a measuring device for analyzing a sample.

Spectrometers, which are used to measure the concentration of at least one analyte in a fluid sample, are well known. To this end, the spectrometer generates a light beam, which it transmits through the fluid sample and which it detects at the other end of the fluid sample by means of photosensor.

The measurement method underlying the spectrometers is based on the known physical phenomenon that a light beam experiences weakening (attenuation) when it passes through a fluid. The attenuation is proportional to the concentration of the analyte and the measurement path within the fluid, through which the light beam needs to pass. This physical connection is described by the Lambert-Beer attenuation law.

Here, samples which themselves do not have or emit inherent radiation are analyzed as fluid samples by means of the spectrometer.

It is an object of the present invention to provide a measuring device which at least enables a measurement and analysis of luminescent samples. Preferably, it is an object of the invention to provide a measuring device which both permits a measurement and analysis of luminescent samples and can be used as a spectrometer.

This object is achieved by a measuring device in accordance with patent claims 1 and 2.

Accordingly, a measuring device is provided for analyzing a luminescent sample and, in particular, for measuring the concentration of at least one analyte in a luminescent sample, said measuring device comprising: a housing with a sample receptacle space for accommodating a sample container, a sample container for accommodating the luminescent sample, a radiation receiver apparatus for receiving radiation emitted by the luminescent sample, and an evaluation apparatus for evaluating the radiation from the luminescent sample received by the radiation receiver apparatus.

Moreover, a measuring device is provided, comprising a base part and a measuring head arranged at the base part in an interchangeable manner, wherein the measuring head is embodied to analyze the luminescent sample or it is embodied as a spectrometer measuring head.

Using this, it is possible to provide a measuring device by means of which luminescent samples can be measured by recording and evaluating the radiation emitted by the sample. Here, the sample can moreover be irradiated or illuminated in order to excite the sample to exhibit afterglow, for example if the sample is a photoluminescent sample.

In contrast to the spectrometers described in relation to the prior art, the measuring devices are advantageous in that it is also possible to analyze luminescent samples. Here, the luminescent samples can be solid, liquid, pasty and/or gaseous.

Advantageous refinements and developments of the present invention emerge from the dependent claims.

In one embodiment of the invention, the measuring device has at least one camera and, for example, a camera data recording apparatus. Here, the camera and/or camera data recording apparatus is provided at e.g. the base part and/or the measuring head. In this case, it is possible, for example, to film by means of the camera the location at which the luminescent sample or the sample for the spectrometer measuring head is taken.

In accordance with a further embodiment of the invention, the measuring device has at least one microphone and, for example, a microphone recording apparatus. Here, the at least one microphone and/or the microphone recording apparatus is provided at e.g. the base part and/or the measuring head. As result, a user of the measuring device can use the latter as a dictation instrument and, for example, dictate or record information relating to the measurement and analysis of the respective sample. As a result, it is possible to dispense with handwritten records and the handiness of the measuring device can additionally be increased.

In another embodiment of the invention, the measuring device has a storage apparatus for storing measurement data of the measuring head. This is advantageous in that the measurement data of the respectively employed measuring head, i.e. of both the measuring head embodied to analyze a luminescent sample and the measurement data of the measuring head embodied as a spectrometer, can be conveniently stored and subsequently read out, for example on a computer in the laboratory.

In a further embodiment of the invention, the measuring device has an indication device. Here, the indication device is provided at e.g. the base part and/or the measuring head. In this way, it is possible to indicate information, such as e.g. measured values, a menu, for example to select a measurement to be carried out, etc., on the indication apparatus. Here, the indication apparatus optionally can be additionally embodied as a touch-sensitive touchpad or touchscreen for the purposes of actuating the menu, etc.

In accordance with one embodiment of the invention, the measuring device has at least one connector for a wireless or wired connection of an external apparatus. Here, the connector is, for example, a USB connector, a cable connector, a Bluetooth connector, a satellite connector or a radio connector, etc. A wireless connector is advantageous in that the measuring device can conveniently transmit information, e.g. measurement data, photos, dictations, etc., wirelessly, in a manner similar to a mobile phone or smartphone. Here, the measuring device can also be embodied with a satellite connector in a manner comparable to satellite telephone, for the purposes of transmitting information, such as e.g. measurement data, photos, dictations, etc., by way of a satellite.

In one embodiment of the invention, the base part and the measuring head are embodied in such a way that they can be plugged together. Here, the base part and the measuring head have an electric interface for electrically connecting the measuring head and the base part.

In a further embodiment of the invention, the spectrometer measuring head is embodied to analyze a fluid sample. Such a measuring head can be used, for example, to examine a sample of a body of water or well.

In one embodiment of the present invention, at least one additional illumination apparatus is provided for illuminating the luminescent sample. This is advantageous in that photoluminescent samples, such as e.g. fluorescent or phosphorescent samples, in particular, can be analyzed as these can be excited to exhibit afterglow by means of the illumination apparatus.

In accordance with one embodiment of the present invention, the measuring device has a control apparatus for open-loop and/or closed-loop control of the illumination apparatus. Here, for example, the illumination duration, the luminosity and/or the illumination interval of the illumination apparatus can be controlled and/or regulated by the control apparatus. This is advantageous in that the illumination can be matched in a targeted manner to a respective luminescent sample by way of the control apparatus and the analysis of the sample can be further improved thereby.

In another embodiment of the present invention, the measuring device has an indication apparatus for indicating a result of the evaluation of the evaluation apparatus. As result, the user of the measuring device can immediately gather the result of the analysis, without needing to connect the measuring device to an external indication apparatus.

In a further embodiment of the present invention, at least two illumination apparatuses are provided. Here, the illumination apparatuses can be actuated individually and/or together by the control apparatus. The provision of a plurality of illumination apparatuses is advantageous in that the sample can be e.g. illuminated from a plurality of directions and/or e.g. illuminated by different types of illumination. By way of example, the illumination apparatuses can radiate light with different wavelengths such that, for example, different analytes present in the sample can be analyzed.

In accordance with one embodiment of the present invention, the housing opening is embodied to be sealable by means of a cover element. Here, the housing opening is sealable, e.g. at least in a light-tight manner, by means of the cover element. As a result of this, it is possible to prevent unwanted radiation from entering into the housing from the outside and being able to impair the analysis of the sample.

In a further embodiment of the present invention, the sample receptacle space has an embodiment that is shielded to the outside in a light-tight manner. This is advantageous in that radiation or light from electronic components—to the extent that these are present in the housing of the measuring device—is not able to reach the sample receptacle space in an unwanted manner and impair the analysis of the sample. Furthermore, it is possible to ensure that a sample in the sample receptacle space is only illuminated by the respective associated illumination apparatus and not, for example, by other electronic components situated in the housing.

In another embodiment of the present invention, the sample container is arranged in the sample container space in a secured or detachable manner and said sample container is embodied in a manner sealable by means of a cover. A detachable sample container is advantageous in that it can be removed from the sample container space of the housing for receiving the luminescent sample, for example a luminescent water sample. A sample container securely connected to the housing can likewise be provided with a luminescent sample in a simple manner, e.g. by way of an apparatus such as a pipette.

In a further embodiment of the present invention, the radiation receiver apparatus has at least one light sensor and/or photosensor. These can form an array in the case of the plurality of light sensors or photosensors.

In accordance with another embodiment of the present invention, the measuring device is embodied as a portable measuring device with at least one dedicated energy source. Here, the energy source can be at least one battery or accumulator. As a result, the measuring device can be used everywhere and, in particular, even where no power lead is present.

In one embodiment of the present invention, the measuring device has a power lead for connection to a power plug or a power lead connector for connecting a power lead.

In a further embodiment of the present invention, a gaseous, solid and/or liquid luminescent sample is measureable as a luminescent sample by means of the measuring device. The luminescent sample can moreover be either pasty or powdery. Likewise, it is possible to analyze organisms, cells and animals, such as e.g. insects, by means of the measuring device, provided that these are luminescent.

Below, the invention will be explained in more detail on the basis of exemplary embodiments, with reference being made to the attached figures of the drawing.

In detail:

FIG. 1 shows a perspective view of the measuring device in accordance with one embodiment of the invention, wherein a base part is connected to a measuring head for measuring luminescent samples;

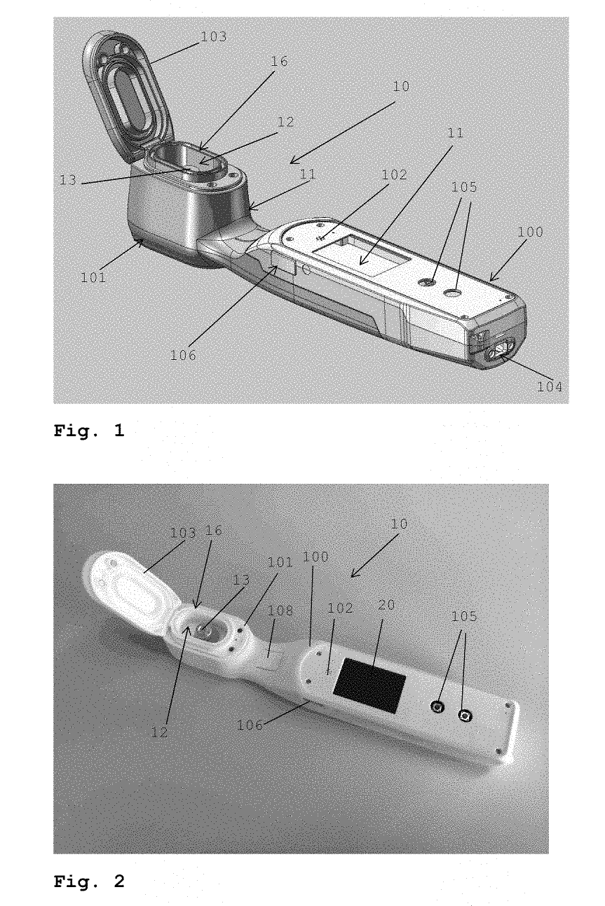

FIG. 2 shows a photo of a measuring device in accordance with FIG. 1;

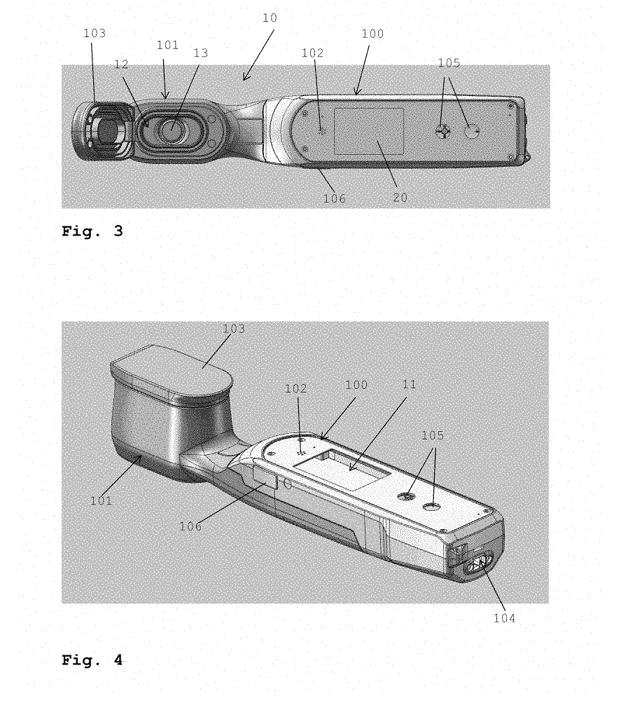

FIG. 3 shows a plan view of the measuring device in accordance with FIG. 1;

FIG. 4 shows a perspective view of the measuring device in accordance with FIG. 1, wherein a cover flap is in the closed position;

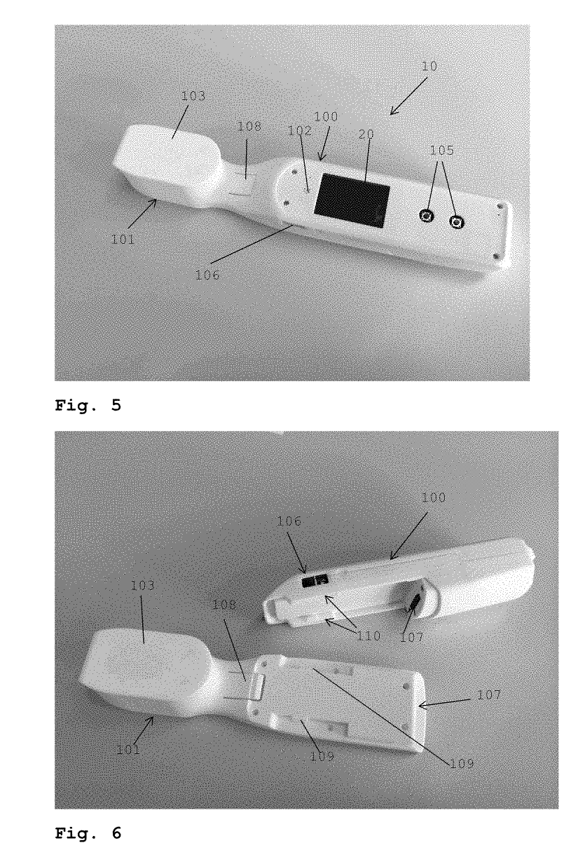

FIG. 5 shows a further photo of the measuring device in accordance with FIG. 1;

FIG. 6 shows an yet further photo of the measuring device in accordance with FIG. 1, wherein the measuring head has been removed from the base part;

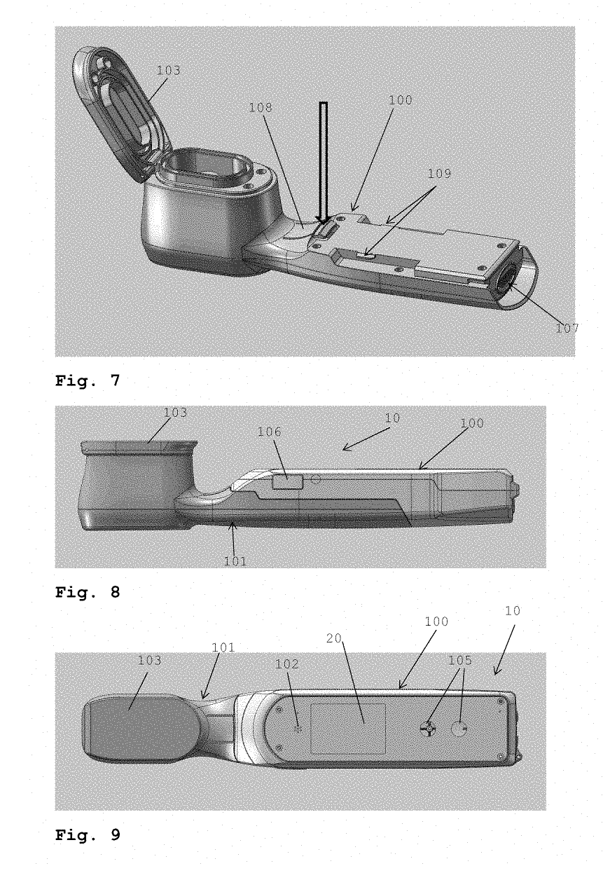

FIG. 7 shows a perspective view of the measuring head of the measuring device in accordance with FIG. 1;

FIG. 8 shows a side view of the measuring device in accordance with FIG. 1, when the cover flap is in the closed position;

FIG. 9 shows a plan view of the measuring device in accordance with FIG. 1, wherein the cover flap is in the closed position;

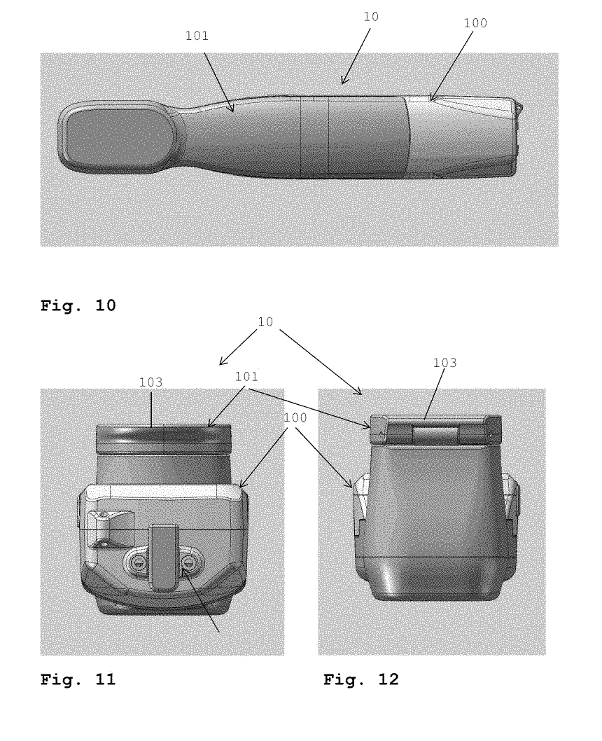

FIG. 10 shows a view of the measuring device in accordance with FIG. 1 from below;

FIG. 11 shows a rear view of the measuring device in accordance with FIG. 1, wherein a USB stick is accommodated in a USB connector of the measuring device;

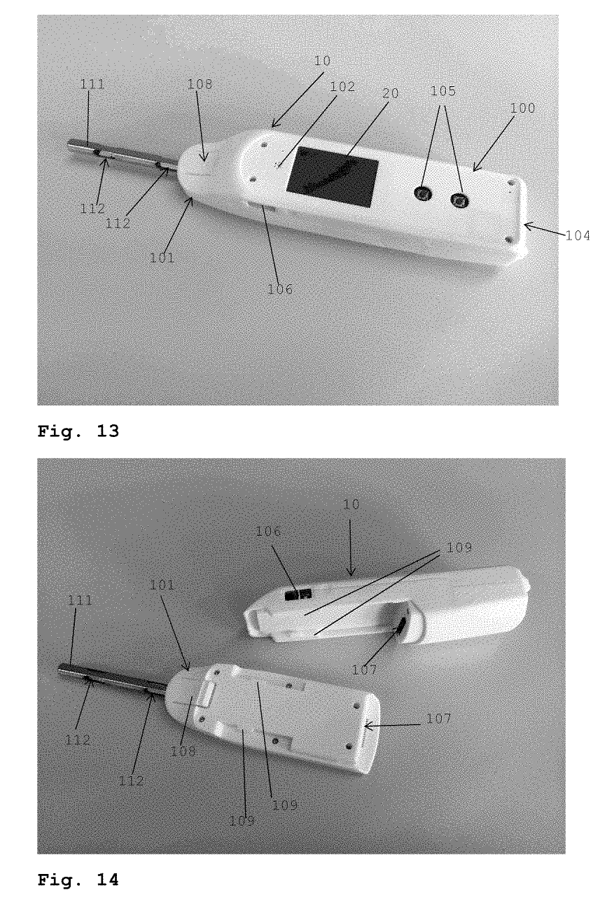

FIG. 12 shows a front view of the measuring device in accordance with FIG. 1;

FIG. 13 shows a photo of a measuring device in accordance with FIG. 1, wherein another measuring head is connected to the base part, wherein the measuring head is a spectrometer measuring head for measuring a fluid sample;

FIG. 14 shows a photo of the measuring device in accordance with FIG. 13, wherein the spectrometer measuring head is removed from the base part; and

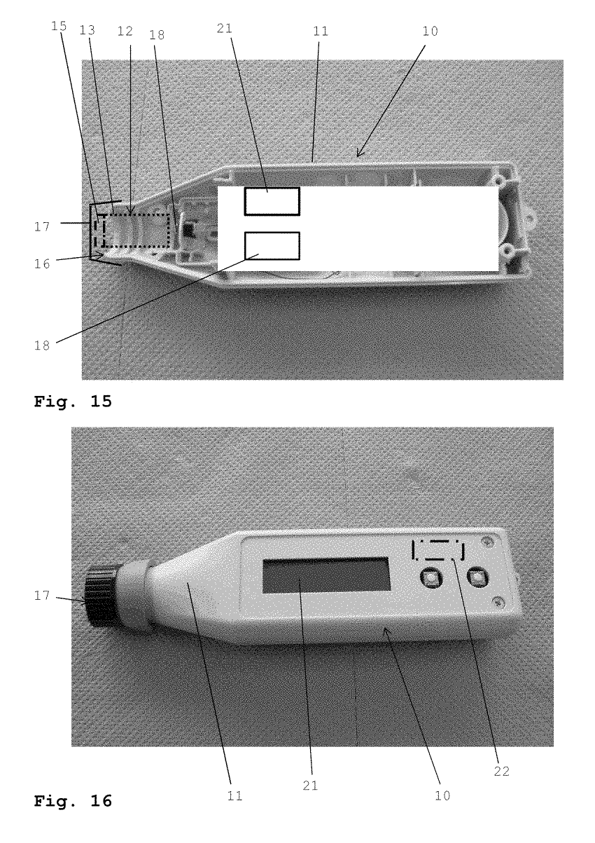

FIG. 15 shows a measuring device in accordance with a further exemplary embodiment of the present invention, wherein part of the housing is removed from the measuring device;

FIG. 16 shows the measuring device in accordance with FIG. 15 and the housing thereof.

In the figures, the same reference signs denote the same or functionally equivalent components, provided that nothing is specified to the contrary.

FIGS. 1 to 12 show a measuring device 10 in accordance with one example embodiment of the present invention, wherein the measuring device 10 has a housing 11 consisting of the base part 100 and a measuring head 101, which is arranged at the base part 100 in an interchangeable manner. In the exemplary embodiment shown in FIGS. 1 to 12, a measuring head for measuring luminescent samples is inserted into the base part 100 as measuring head 101.

Luminescence is the optical radiation of a physical system which arises during the transition from an excited state to the ground state. Here, the cause is radiating deactivation.

Depending on the type of excitation, a distinction is made between various types of luminescence, including e.g. the so-called photoluminescence, the so-called chemiluminescence and the so-called bioluminescence.

In the case of photoluminescence, there is an excitation of the system by photons. Here, a distinction is made between phosphorescence and fluorescence depending on the time duration between excitation and emission of the light. Fluorescence is the spontaneous emission of light, shortly after the excitation of the material. Phosphorescence in turn is the property of a substance to exhibit afterglow in the dark after illumination with light, for example with visible light or UV light. Cause is radiating deactivation.

In chemiluminescence, the excitation of the system is carried out by chemical reaction. By way of example, luminol can be used here for detecting blood.

In bioluminescence, the excitation of the system is carried out by a chemical reaction in a living organism, for example a cell, a bacterium or an animal such as e.g. fireflies, in which luciferin is oxidized.

The sample measuring head 101 for analyzing a luminescent sample has a sample receptacle space 12, in which a sample container 13 with a luminescent sample is introducible and analyzable. The sample container 13 is sealable in this case, in particular sealable in a tight manner, by means of e.g. a cover such that the sample cannot escape from the sample container 13 in an unwanted manner.

Here, the sample container 13 is transparent, for example made of a transparent plastic or a transparent glass, for the purposes of passing the radiation emitted by the luminescent sample, e.g. visible light, and optionally for passing radiation of at least one additional illumination apparatus for illuminating the luminescent sample in order to excite the latter to exhibit afterglow.

Here, the sample container 13 can be integrated into the measuring head in a secure or detachable manner. If the sample container 13, e.g. a glass vial, is integrated detachably into the measuring head 101, it can easily be removed from the measuring head 101 by way of a corresponding housing opening 16 of the measuring head, filled with the luminescent sample and subsequently inserted into the measuring head 101. In the case where the sample container 13 is securely integrated into the measuring head 101, the cover can be removed for filling the sample container 13 and said cover can reseal the sample container 13 after the latter has been filled. Like the sample container, the cover can likewise have a transparent embodiment.

The housing opening 16 of the measuring head for inserting and/or filling the sample container 13 has a sealable embodiment, in particular an embodiment that is sealable in a light-tight manner, with a cover element, e.g. a cover flap 103 or a sealing cap not depicted here.

Here, the cover flap 103 is fastened to the housing of the measuring head 101 in a swivelable manner, as shown in FIGS. 1-12. Here, the cover flap 103 can be swiveled between an open position, as shown in FIGS. 1, 2, 3 and 7, in which the sample receptacle space 12 is accessible, and a closed position, as shown in FIGS. 4, 5, 6 and 8-12, in which the sample receptacle space 12 is closed.

What this can ensure is that no light can penetrate into the measuring head and the sample receptacle space 12 thereof from the outside and falsify the measurement result.

Moreover, e.g. at least one radiation receiver apparatus for receiving the radiation emitted by the luminescent sample and for the conversion into electric signals is provided in the sample receptacle space 12 of the measurement head. By way of example, a light sensor, a photomultiplier, avalanche diodes or a photosensor can be used as a radiation receiver apparatus for receiving radiation from the luminescent sample, such as e.g. light, etc. Here, the photosensor can have at least one photodiode. Instead of a light sensor, a photomultiplier, avalanche diodes or a photosensor, it is also possible to provide any other suitable radiation receiver apparatus or combination of radiation receiver apparatuses, which is suitable for receiving the radiation, such as e.g. light, etc., emitted by the luminescent sample.

Optionally, the at least one additional illumination apparatus can be furthermore additionally provided in the measuring head 101 for the purposes of analyzing a photoluminescent sample as an example of a luminescent sample. The luminescent sample is illuminated by suitable radiation by means of the illumination apparatus to excite the luminescent sample to exhibit afterglow. By way of example, such luminescent or photoluminescent samples are fluorescent samples or phosphorescent samples. Here, the illumination apparatus is likewise arranged e.g. in the sample receptacle space 12.

By way of example, provision can be made of a plurality of illumination apparatuses, wherein the illumination apparatuses all emit light with the same wavelength or light with different wavelengths for the purposes of illuminating the luminescent sample. As a result of this, it is possible, for example in an alternating manner, to illuminate a luminescent sample to be examined with light with different wavelengths in order e.g. to determine a plurality of, or different, analytes.

The radiation receiver apparatus is connected to an evaluation apparatus for evaluating the signals of the radiation receiver apparatus for the purposes of analyzing the luminescent sample.

Here, the evaluation apparatus can be part of the measuring device 10 and provided in the base part 100 and/or the measuring head 101. Additionally or alternatively, the measuring device 10 can also be coupleable to an external evaluation apparatus and, for example, have a connector, such as the USB connector 104 shown in FIGS. 1, 4 and 11, a power or network connector and/or a wireless connector, e.g. a Bluetooth connector, radio connector, a satellite connector comparable to a satellite telephone, etc. The invention is not restricted to the aforementioned connectors for connecting an external apparatus, e.g. an external evaluation apparatus. Here, the external apparatus, in particular the external evaluation apparatus, can be a PC, a laptop, a smartphone, a tablet PC, etc., with this list merely being exemplary and not exhaustive. By way of example, evaluation software for evaluating the data from the measuring device can be provided as an app and it can e.g. be loadable onto a smartphone or tablet PC.

Optionally, the measuring device 10 additionally has a storage apparatus for storing data from the measuring device 10, for example data from the radiation receiver apparatus, etc.

Moreover, an indication apparatus 20 is provided to indicate e.g. the result of the evaluation of the evaluation apparatus and/or to indicate at least one menu, etc. Indicating the results of the evaluation apparatus and/or at least one menu can also take place, additionally or alternatively, on an external apparatus connected to the measuring device 10. Here, as described above, the external apparatus can be e.g. a tablet PC, a smartphone, a PC, a laptop, which each have a dedicated display, and moreover, as an evaluation apparatus and/or storage apparatus, can themselves store and/or evaluate the data from the measuring device 10, and indicate the data on a dedicated display and/or on the indication apparatus 20 of the measuring device 10.

By way of example, the indication apparatus 20 of the measuring device 10 is provided on the base part, as shown in FIGS. 1, -5 and 9. In FIGS. 1 and 4, only the opening in the housing 11 for the indication apparatus is shown. The measuring device 10 can have a key control for navigating between various menus or for indicating various results of the evaluation by the evaluation apparatus 20, as shown in FIGS. 1-5 and 9. Here, the key control has e.g. at least one or two keys 105. Likewise, the indication apparatus 20 can also, additionally or alternatively, be embodied as a touchscreen, etc.

Moreover, optionally, a control apparatus can be additionally provided in the measuring head 101 and/or in the base part 100 of the measuring device 10 for the purposes of open-loop and/or closed-loop control of e.g. the illumination of the respective illumination apparatus of the measuring head 101. By way of example, the control apparatus can control and/or regulate the illumination duration, the luminosity, the illumination interval of the illumination apparatus, etc. Moreover, it is also possible to actuate, either together or independently, a plurality of illumination apparatuses by means of the control apparatus for the purposes of analyzing a luminescent sample in the sample receptacle space 12 of the measuring device 10.

As shown in FIGS. 1-5 and 9, the measuring device additionally has a microphone apparatus with at least one microphone 102, and a microphone recording apparatus for recording the content spoken into the microphone 102. Here, the microphone recording apparatus can be part of the measuring device 10 and/or the content spoken into the microphone 102 can be transmitted from the measuring device 10 wirelessly and/or by wires to an external apparatus, such as a smartphone, a server, a laptop, a PC, a tablet PC, etc.

In this manner, the user can, for example, very conveniently dictate e.g. information, such as measurement conditions, the measurement location, etc., into the measuring device 10 in situ by means of the microphone 102. This increases the handling convenience of the measuring device 10. Subsequently, the information recorded in the recording device can be listened to without problems using the measuring device 10 and/or it can be transmitted, either wirelessly or in a wired manner, to an external apparatus, such as the above-described smartphone, the tablet PC, the PC, the laptop, etc., and optionally be listened to there as well. As described above, a wireless or wired transmission can be implemented by means of a connector, for example in the form of a Bluetooth connector or USB connector 104, etc.

Furthermore, the measuring device 10 has at least one camera 106, which is arranged in the measuring head 101 or the base part 100, as shown in FIGS. 1, 2, 4-6, 8 and 9. In the exemplary embodiment shown in FIGS. 1, 2, 4-6, 8 and 9, the camera 106 is provided in the base part 100 and e.g. arranged laterally on the base part 100. By means of the camera 106, it is possible, for example, to film the measurement conditions, the measurement location, the point where a sample is taken and store this in the camera data recording apparatus. Here, the camera data recording apparatus can be part of the measuring device 10 and/or the camera data can be transmitted wirelessly and/or in a wired manner from the measuring device 10 to an external apparatus, such as a smartphone, a server, a laptop, a PC, a tablet PC, etc.

In the case of the measuring head connected to the base part in FIGS. 1-12, the above-described control apparatus can actuate and/or regulate e.g. at least the illumination apparatus, the radiation receiver apparatus, the indication apparatus 20, the camera, the microphone apparatus, the storage apparatus, the camera data recording apparatus, the microphone recording apparatus and/or the evaluation apparatus. Additionally or alternatively, the measuring device 10 can likewise be connected by way of the connector thereof, also in a wireless or wired manner, to an external control apparatus.

Moreover, the sample receptacle space 12 can be embodied to be additionally sealable in a light-tight manner or shielded from ambient light in the measuring head 101 of the measuring device 10 such that, except for light of the illumination apparatus, which may additionally be present, for the targeted illumination of the luminescent sample in the sample receptacle space 12, no light is able to penetrate in an unwanted manner into the sample receptacle space 12 and into the sample contained therein from outside of the measuring head of the measuring device 10 or else, to the extent that these are present, from the light sources within the measuring head 101.

As described above and shown in FIGS. 1-5 and 9, the measuring device 10 has a display as indication apparatus 20 for indicating e.g. the result of the analysis of the sample contained in the sample container. The measuring device 10 can be embodied as a portable measuring device and can have a dedicated energy source for feeding energy to apparatuses, such as e.g. the control apparatus, the evaluation apparatus, the indication apparatus 20, the illumination apparatus, the radiation receiver apparatus, the camera 106 and/or the microphone apparatus 102. Here, the energy source is e.g. a battery apparatus and/or an accumulator. Additionally or alternatively, the measuring device 10 can also have the above-described connector, such as e.g. a USB connector 104 and/or a cable or power connector for connecting a power lead or a power lead for connecting to a power plug, etc., in order to supply energy to the measuring device 10.

The above-described camera data recording apparatus, the storage apparatus for storing measurement data in particular and/or the microphone recording apparatus can be provided in the measuring device 10 as a storage apparatus or as a dedicated storage apparatus in each case. Additionally or alternatively, the information from the camera data recording apparatus, the storage apparatus and/or the microphone recording apparatus can also be transferred directly without buffer storage in the measuring device 10, or in addition to buffer storage in the measuring device 10, to an external apparatus by way of the connector, in particular the USB connector 104, radio connector or Bluetooth connector. Here, as described above, the external apparatus is e.g. a smartphone, a laptop, a PC, a tablet PC, etc.

As shown in FIGS. 6 and 7, the measuring head 101 is arranged at the base part 100 in an interchangeable manner. Here, the base part 100 and the measuring head 101 are embodied in such a way that they can be plugged together. Here, an electrical interface 107, for example an electrical plug-in connection, is provided at the base part 100 and the measuring head 101 for the purposes of electrically connecting the base part 100 and the measuring head 101. Optionally, the measuring head 101 can additionally have a latching element 108, by means of which the measuring head 101 can additionally latch onto the base part 100. Here, the latching connection can be released by pressing the latching element 108, as is indicated by an arrow in FIG. 7. Optionally, the measuring head 101 additionally has retaining lugs 109, which can be accommodated in corresponding receptacles 110 of the base part when the measuring head and the base part 100 are plugged together for the purposes of affixing the measuring head 101 to the base part 100.

In FIGS. 13 and 14, the base part 100 of the measuring device 10 described above in relation to FIGS. 1-12 is equipped with a different measuring head 101. Instead of the measuring head for measuring luminescent samples, inserted in FIGS. 1-12, a spectrometer measuring head 101 is inserted in the exemplary embodiment in FIGS. 13 and 14.

The spectrometer measuring head 101 serves to measure the concentration of at least one analyte in a fluid sample.

The fluid sample can be a gas, a liquid or a mixture thereof. Moreover, the fluid sample can also contain a certain solids component, for example dust.

The analyte preferably is a substance preferably dissolved in water. Examples of such substances are oxygen, ozone, chlorine (free chlorine, total chlorine), nitrogen compounds (total nitrogen), magnesium, calcium, copper, potassium, iron, zinc, heavy metals, ammonium, cyanuric acid, cyanide, urea, carbonate (water hardness), hydrogen peroxide, chloride, nitrite, nitrate or phosphate. However, the fluid sample can likewise be a gas, in particular air. By way of example, the spectrometer measuring head 101 can be used to measure the concentration of carbon monoxide, carbon dioxide, water components, alcohols, turbidities, dusts in the air. By way of example, the fluid samples can also be ground samples or fertilizers. Measuring a pH value in the fluid sample by means of the spectrometer measuring head 101 is also possible.

The spectrometer measuring head 101 has one or more light sources, for example LEDs, in particular laser LEDs. The one or more light sources generate a light beam.

The spectrometer measuring head 101 furthermore has a photosensor for receiving the light beam. The photosensor converts the incident light beam into electric signals.

Furthermore, the spectrometer measuring head 101 is embodied with a measuring section in the beam path of the light beam. With the measuring section thereof, the spectrometer measuring head 101 is introducible into the fluid sample. The measuring section is provided in a modifiable manner and can be increased and decreased in terms of size. The principle of the modifiable measuring section in a spectrometer is moreover described in WO2010/146110 A1 by IFE GmbH and in DE 10 2009 025 261 by IFE GmbH.

To this end, the spectrometer measuring head 101 is for example embodied as follows:

A light guide, e.g. an acrylic rod, a macrolon rod, a glass rod or a glass fiber cable, is arranged in the beam path of the light beam. The light guide has a first portion, which is securely housed in the spectrometer measuring head 101, and a second portion, which extends out of the spectrometer measuring head 101 into a sleeve 111.

Like in FIGS. 13 and 14, the sleeve 111 is provided with a plurality of slots 112. One of the slots 112 is always connected to the measuring section, irrespective of the position of the sleeve 111 in relation to the spectrometer measuring head 101 or the light guide; i.e., the fluid sample can be taken from the fluid, for example a body of water. In accordance with the present exemplary embodiment, taking the sample can easily be undertaken thus by immersing the slots 112, and hence also by immersing the sleeve 111 including the end piece, into the fluid.

The sleeve 111 has a first portion, by means of which it extends into the spectrometer measuring head 101. The portion is held in a movable manner in a receptacle space of the spectrometer measuring head 101 along the beam path of the light beam in the same. A second portion of the sleeve 111 extends out of the spectrometer measuring head 101 to the outside and, in the process, surrounds a second portion of the light guide. A third portion of the sleeve 111 adjoins the second portion of the sleeve 111, said third portion bounding the fluid sample at the circumference thereof. An end piece in turn adjoins the third portion. The end piece seals the ring-shaped cross section of the sleeve 111 in a fluid-tight manner.

Hence, the measuring section is defined between the end piece and a front side of the light guide. Along the beam path of the light beam, the fluid sample is bounded by the end piece and the front side and, in terms of circumference, by the third portion of the sleeve 111, as mentioned. The end piece has the photosensor and, preferably, a lens element which focuses the incident light beam onto the photosensor.

The measuring section is set by virtue of the sleeve 111 now being moved into, or out of, the receptacle space of the spectrometer measuring head 101 and it can therefore easily be adapted to the requirements of a concentration measurement of a respective analyte.

The light beam is coupled-in at the other front side of the light guide.

Moreover, the measuring device 10 has the control apparatus, described above with respect to FIGS. 1-12, which, for example, actuates the light sources, photosensor etc. of the spectrometer measuring head 101 in the case where the spectrometer measuring head 101 is connected to the base part 100.

The above-described indication apparatus 20 of the measuring device 10 which, is provided in e.g. the base part 100 indicates e.g. the measured analyte concentrations in the case of the spectrometer measuring head 101 inserted in FIGS. 13 and 14.

By means of the keys 105 described above with respect to FIGS. 1-12, it is possible to operate menus of the indication apparatus 20 and enable a corresponding selection.

Likewise, it is possible to record and store information from a user of the measuring device 10 by means of the microphone apparatus, e.g. arranged in the base part 100, with at least one microphone 102, and a microphone recording apparatus. A corresponding statement applies to the camera 106, e.g. arranged in the base part 100, and the camera data recording apparatus.

The evaluation apparatus for evaluating the data of the spectrometer measuring head 101 can be part of the measuring device 10 and it can be provided in the base part 100 and/or in the measuring head 101. Additionally or alternatively, the measuring device 10 can also be coupleable to an external evaluation apparatus, as described above with respect to FIGS. 1-12, and e.g. have a connector, such as the USB connector 104 shown above in FIGS. 1, 4 and 11, a power connector or a network cable connector and/or a wireless connector, e.g. a Bluetooth connector, radio connector, a satellite connector comparable to a satellite telephone, etc.

As was already described above with respect to FIGS. 6 and 7 and as is likewise shown in FIG. 14, the measuring head 101 is arranged at the base part 100 in an interchangeable manner. Here, as described above, the measuring head 101 is embodied in such a way that it can be plugged together with e.g. the base part 100. Here, an electrical interface 107, e.g. an electrical plug-in connection, is provided at the base part 100 and at the spectrometer measuring head 101 for electrically connecting the base part 100 to the spectrometer measuring head 101. Optionally, the spectrometer measuring head 101 can additionally have a latching element 108, by means of which the spectrometer measuring head 101 can additionally latch onto the base part 100. Here, the latching can be released by pressing the latching element 108, as indicated above by means of an arrow in FIG. 7. Optionally, the spectrometer measuring head 101 additionally has retaining lugs 109 for the purposes of affixing the measuring head 101 at the base part 100, which retaining lugs can be accommodated in corresponding receptacles 110 of the base part 100 when the spectrometer measuring head 101 and the base part 100 are plugged together.

Instead of being embodied with an interchangeable measuring head 101, the measuring device 10 can also be embodied like in the following exemplary embodiment of the invention. Here, the exemplary embodiment is elucidated on the basis of FIGS. 15 and 16.

Here, FIG. 15 shows a measuring device in accordance with a further exemplary embodiment of the present invention, wherein part of the housing 11 has been removed from the measuring device 10.

Here, the measuring device 10 is embodied in such a way that luminescent samples can be measured or analyzed. The luminescence and the various types of luminescence, such as e.g. the so-called photoluminescence, the so-called chemiluminescence and the so-called bioluminescence, were already elucidated in detail with reference to FIGS. 1-12 in this case and are therefore not repeated again.

The measuring device 10 has a sample receptacle space 12 in the housing 11 for the purposes of analyzing a luminescent sample, into which sample receptacle space a sample container 13 with a luminescent sample 14 is introducible and analyzable. Here, the sample container 13 is e.g. sealable by means of a cover, in particular sealable in a tight manner, such that the sample cannot escape from the sample container 13 in an unwanted manner.

Here, the sample container 13 is transparent, for example made of a transparent plastic or a transparent glass, for the purposes of passing the radiation emitted by the luminescent sample 14, e.g. visible light, and optionally for the purposes of passing the radiation from at least one additional illumination apparatus 15 for illuminating the luminescent sample 14, in order to excite the latter to exhibit afterglow.

Here, the sample container 13 can be securely or detachably integrated into the housing 11. If the sample container 13 is detachably integrated into the housing 11, it can easily be removed from the housing 11 through a corresponding housing opening 16, it can easily be filled with a luminescent sample 14 and it can subsequently be inserted into the housing 11. In the case where the sample container 13 is securely integrated into the housing 11, the cover can be removed for filling the sample container 13 and said cover can reseal the sample container 13 after the latter has been filled. Like the sample container, the cover can likewise have a transparent embodiment.

The housing opening 16 for inserting and/or filling the sample container 13 preferably has a sealable embodiment with a cover element, e.g. a sealing cap 17, in particular an embodiment that is sealable in a light-tight manner. In this way, it is possible to ensure that no light can penetrate into the housing and the sample receptacle space thereof from the outside and distort the measurement result.

Furthermore, at least one radiation receiver apparatus 18 is provided in the housing 11, preferably in the sample receptacle space 12 of the housing 11, for the purposes of receiving the radiation emitted by the luminescent sample 14 and converting this into electric signals. By way of example, a light sensor or a photosensor can be used as a radiation receiver apparatus 18 for receiving radiation, e.g. light, etc., from the luminescent sample 14. Here, the photosensor can have at least one photodiode. Instead of a light sensor or a photosensor, it is also possible to provide any other suitable radiation receiver apparatus or combination of radiation receiver apparatuses, which is suitable for receiving the radiation, such as e.g. light, etc., emitted by the luminescent sample.

Optionally, the at least one additional illumination apparatus 15 can be provided in the housing 11 for analyzing a photoluminescent sample as an example of a luminescent sample 14. The illumination apparatus 15 is used to illuminate the luminescent sample 14 with suitable radiation in order to excite the luminescent sample 14 to exhibit afterglow. By way of example, such luminescent or photoluminescent samples 14 are fluorescent samples or phosphorescent samples. Here, the illumination apparatus 15 is likewise arranged in e.g. the sample receptacle space 12, as indicated by a dashed line in FIG. 1.

By way of example, a plurality of illumination apparatuses 15 can be provided, wherein the illumination apparatuses 15 all emit light of the same wavelength, or light with different wavelengths, for the purposes of illuminating the luminescent sample 14. As a result, it is possible to illuminate a luminescent sample 14 to be examined with light of different wavelengths, e.g. in an alternating fashion, in order e.g. to determine a plurality of, or different, analytes.

For the purposes of analyzing the luminescent sample 14, the radiation receiver apparatus 18 is connected to an evaluation apparatus 19 for evaluating the signals from the radiation receiver apparatus 18. Moreover, provision is made of an indication apparatus 20 for indicating a result of the evaluation of the evaluation apparatus 19.

Moreover, provision can optionally additionally be made of a control apparatus 21 for open-loop and/or closed-loop control of the illumination of the respective illumination apparatus 15. By way of example, the control apparatus can control and/or regulate, the illumination duration, the luminosity, the illumination interval of the illumination apparatus 15, etc. Moreover, the control apparatus 21 can also be used to actuate a plurality of illumination apparatuses 15, either together or independently of one another, for the purposes of analyzing a luminescent sample 14 in a sample receptacle space 12 of the measuring device 10.

Moreover, sample receptacle space 12 can be embodied to be additionally sealable in a light-tight manner or shielded from ambient light in the housing 11 of the measuring device 10 such that, except for light of the illumination apparatus 15, which may additionally be present, for the targeted illumination of the luminescent sample 14 in the sample receptacle space 12, no light is able to penetrate in an unwanted manner into the sample receptacle space 12 and into the sample contained therein from outside of the housing 11 of the measuring device 10 or else, to the extent that these are present, from the light sources within the housing 11.

FIG. 16 shows the measuring device 10 in accordance with FIG. 15 and the housing 11 thereof. As described above with respect to FIG. 15, the housing opening 16 for inserting and/or filling the sample container 13 is sealed, preferably in a tight manner, in particular at least in a light-tight manner, by means of a cover element, e.g. a sealing cap 17. In the case of a light-tight seal of the housing opening 16, no light penetrates into the housing 11 from the outside in an unwanted manner. As described above with respect to FIG. 15, the sample receptacle space 12 can likewise be embodied to be sealable in a light-tight manner or shielded from ambient light, wherein, in one exemplary embodiment of the invention, the cover element 17 e.g. seals one end of the sample receptacle space 12 in a light-tight manner such that no light is able to penetrate into the housing 11 and the sample receptacle space 12 from the outside in an unwanted manner.

As shown in FIG. 15, the measuring device 10 has a display as an indication apparatus 20 for indicating a result of the analysis of the sample contained in the sample container. The measuring device 10 can be embodied as a portable measuring device 10 and have a dedicated energy source 22, as indicated in FIG. 15 by a dash-dotted line, for feeding energy to apparatuses, such as the control apparatus, the evaluation apparatus, the indication apparatus, the illumination apparatus, the radiation receiver apparatus. Here, the energy source 22 is e.g. a battery apparatus and/or an accumulator. Additionally or alternatively, the measuring device 10 can also have a cable connector for connecting a power lead or a power lead for connecting to a power plug in order to supply energy to the measuring device 10.

Even though the present invention was described above on the basis of preferred exemplary embodiments, it is not restricted thereto, but rather modifiable in multifaceted ways.

In one embodiment of the measuring device 10 in accordance with FIGS. 1-12, the cover element or the cover flap 103 of the measuring head 101 for sealing the housing opening 16 can be embodied to seal the sample container 13 at the same time such that the separate cover for the sample container can be dispensed with.

The same applies to the embodiment described with respect to FIGS. 15 and 16. In one embodiment of the invention, the cover element of the measuring device 10 in FIGS. 15 and 16 for sealing the housing opening can be embodied to seal the sample container at the same time such that the separate cover for the sample container can be dispensed with.

As a luminescent sample, the measuring device described in an exemplary manner with respect to FIGS. 1 to 16 above can analyze solid, liquid, pasty, powdery and/or gaseous samples, and also organisms, cells, animals, such as e.g. insects, etc., to the extent that these are luminescent.

### LIST OF REFERENCE SIGNS

10 Measuring device
11 Housing
12 Sample receptacle space
13 Sample container
14 Sample
15 Illumination apparatus
16 Housing opening
17 Sealing cap
18 Radiation receiver apparatus
19 Evaluation apparatus
20 Indication apparatus
21 Control apparatus
22 Energy source
100 Base part
101 Measuring head
102 Microphone
103 Cover flap
104 USB connector
105 Key
106 Camera
107 Electrical interface
108 Latching element
109 Retaining lugs
110 Receptacle (base part)
111 Sleeve
112 Slot

What is claimed is:

1. A measuring device for analyzing a luminescent sample and for measuring the concentration of at least one analyte in a luminescent sample, comprising:
a housing with a sample receptacle space for accommodating a sample container,
a sample container for accommodating the luminescent sample,
a radiation receiver apparatus for receiving radiation emitted by the luminescent sample, and
an evaluation apparatus for evaluating the radiation from the luminescent sample received by the radiation receiver apparatus.

2. A measuring device comprising a base part and a measuring head arranged at the base part in an interchangeable manner, wherein the measuring head is embodied to analyze a luminescent sample or is embodied as a spectrometer measuring head.

3. The measuring device of claim 2, wherein the measuring device has at least one camera and a camera data recording apparatus, wherein the camera and/or camera data recording apparatus is provided at the base part and/or the measuring head.

4. The measuring device of claim 2, wherein the measuring device has at least one microphone and a microphone recording apparatus, wherein the at least one microphone and/or the microphone recording apparatus is provided at the base part and/or the measuring head.

5. The measuring device of claim 2, wherein the measuring device has a storage apparatus for storing measurement data of the measuring head.

6. The measuring device of claim 2, wherein the measuring device has an indication device, wherein the indication device is provided at the base part and/or the measuring head.

7. The measuring device of claim 2, wherein the measuring device has a connector for a wireless or wired connection of an external apparatus, wherein the connector is a USB connector, a cable connector, a Bluetooth connector, a satellite connector or a radio connector.

8. The measuring device of claim 2, wherein the base part and the measuring head are embodied in such a way that they can be plugged together and wherein the base part and the measuring head have an electric interface for electrically connecting the measuring head and the base part.

9. The measuring device of claim 2, wherein the spectrometer measuring head analyzes a fluid sample.

10. The measuring device of claim 1, wherein at least one illumination apparatus is provided for illuminating the luminescent sample, wherein the luminescent sample is a photoluminescent sample.

11. The measuring device of claim 10, wherein the measuring device has a control apparatus for open-loop and/or closed-loop control of the illumination apparatus and wherein the illumination duration, the luminosity and/or the illumination interval of the illumination apparatus is controllable and/or regulable by the control apparatus.

12. The measuring device of claim 10, wherein the measuring device has an indication apparatus for indicating a result of the evaluation of the evaluation apparatus.

13. The measuring device of claim 11, wherein at least two illumination apparatuses are provided, wherein the illumination apparatuses are actuatable individually and/or together by the control apparatus.

14. The measuring device of claim 10, further comprising a cover element adapted for sealing a housing opening in a light-tight manner.

15. The measuring device of claim 10, wherein the sample receptacle space has an embodiment that is shielded to the outside in a light-tight manner.

16. The measuring device of claim 10, wherein the sample container is arranged in the sample receptacle space in a secured or detachable manner and comprising a cover adapted for sealing said sample container.

17. The measuring device of claim 10, wherein the radiation receiver apparatus has at least one light sensor and/or photosensor.

18. The measuring device of claim 10, wherein the measuring device is embodied as a portable measuring device with at least one dedicated energy source.

19. The measuring device of claim 10, wherein the measuring device has a power lead for connection to a power plug or a power lead connector for connecting a power lead.

20. The measuring device of claim 10, wherein the measuring device is adapted to measure a solid, pasty, powdery, liquid and/or gaseous luminescent sample as a luminescent sample.

21. The measuring device of claim 2, wherein at least one illumination apparatus is provided for illuminating the luminescent sample, wherein the luminescent sample is a photoluminescent sample.

22. The measuring device of claim 21, wherein the measuring device has a control apparatus for open-loop and/or closed-loop control of the illumination apparatus and wherein the illumination duration, the luminosity and/or the illumination interval of the illumination apparatus is controllable and/or regulable by the control apparatus.

23. The measuring device of claim 22, wherein at least two illumination apparatuses are provided, wherein the illumination apparatuses are actuatable individually and/or together by the control apparatus.

24. The measuring device of claim 21, wherein the measuring device is embodied as a portable measuring device with at least one dedicated energy source.

25. The measuring device of claim 21, wherein the measuring device has a power lead for connection to a power plug or a power lead connector for connecting a power lead.

26. The measuring device of claim 21, wherein the measuring device is adapted for measuring a solid, pasty, powdery, liquid and/or gaseous luminescent sample as a luminescent sample.
